(19) United States
(12) Patent Application Publication
(10) Pub. No.: US 2025/0002828 A1
(43) Pub. Date: Jan. 2, 2025

(54) METHOD FOR BOILING WORT

(71) Applicant: BANKE GMBH, Taufkirchen (DE)

(72) Inventors: Friedrich Banke, Markt Schwaben (DE); Stefan Pfister, Eggolsheim (DE)

(21) Appl. No.: 18/757,935

(22) Filed: Jun. 28, 2024

(30) Foreign Application Priority Data
Jun. 28, 2023 (DE) DE 102023117034.1

(51) Int. Cl. C12C 7/20; C12C 13/02

(52) U.S. Cl. CPC C12C 7/20; C12C 13/02

(57) ABSTRACT

In a brewing system with a hot water layered storage tank (2) having a high-temperature area (2′) and a low-temperature area (2″), which has at least one high-temperature water inlet (20, 21, 22), at least one high-temperature water outlet (23), at least a low-temperature water inlet (24) and at least one low-temperature water outlet (25), with a mash vessel (3), a lauter tun (4) or mash filter fluidly connected to the mash vessel (3) via a mash line (34), a wort kettle (5), which has a lauter wort inlet (50), a wort outlet (51) and a vapor condenser (6) with a low-temperature water connection (60) and a high-temperature water connection (61), the lauter wort inlet (50) being connected via a lauter wort line (52). is fluidly connected directly or indirectly to the lauter tun (4) or the mash filter, the low-temperature water outlet (25) of the hot water stratified storage tank (2) being connected to the low-temperature water connection (60) of the vapor condenser (6) and the high-temperature water inlet (21) of the hot water layered storage tank (2) is in fluid connection with the high-temperature water connection (61) of the vapor condenser (6), it is provided that the hot water layered storage tank (2) is connected to a fresh water supply (7′) via a fresh water supply line (70).) is in fluid communication and that the high-temperature water outlet (23) of the hot water stratified storage tank (2) is in fluid communication with a hot water inlet (33) of the mash vessel (3) via a mash water line (32). Alternatively or additionally, it can be provided that a wort cooler (9) is provided in the fresh water supply line, to which cold water is supplied via an external inflow line (71) which is fluidly connected to the fresh water supply (7′), which is heated in the wort cooler (9), and which is fluidly connected via an inner inflow line (72) to the high-temperature water inlet (20) of the hot water stratified storage tank (2), the outer inflow-line (71) and the inner inflow line (72) being the fresh water supply line (70) of the hot water-Layered memory (2).

### RELATED APPLICATIONS

This application claims priority from and incorporates by reference German patent application 10 2023 117 034.1, filed on Jun. 28, 2023.

### FIELD OF THE INVENTION

The present invention relates to a method for wort boiling in a brewing plant. It also relates to a brewing plant which is particularly suitable for performing the method.

### BACKGROUND OF THE INVENTION

Energy management in brewing plants is becoming increasingly important in regard of rising energy costs. Most of the energy required for a brewing method in a brewing plant is thermal energy, which is needed to a not inconsiderable extent to heat the lautered wort before it is fed into the wort kettle and to boil the wort in the wort kettle. However, boiling the wort also produces exhaust vapor, with which thermal energy is discharged from the wort kettle. The use of this thermal energy contained in the exhaust vapor in a brewing system to heat up process liquid or heat transfer liquid, which has a lower temperature level, is well known and has been used in practice for a long time. This makes it even more important to constantly strive to minimize heat losses in the various heat exchange methods and to further improve the thermal energy efficiency of brewing plants. Heat exchange circuits are usually provided for this purpose, which are separated from the flow of the brewing process liquid, for example the wort.

The document DE 10 2022 131 423 B3, which has not yet been published, discloses a brewing plant with a hot water storage device having a high temperature section and a low temperature section, in which fresh water is used as a heat transport medium in an open heat transport system for exchanging thermal energy between the individual plant components, with the fresh water being heated in the vapor condenser, for example, and temporarily stored in the hot water storage device. From there, it is fed into the brewing process as hot brewing water.

EP 2 516 614 B1 discloses a device and a method for recovering energy in a beer brewery, wherein a heat exchange circuit separate from the process fluid flow is provided. The heat exchange circuit contains a heat transport fluid, for example water, and forms a closed piping system with heat exchangers for heat transfer between the process fluid and the heat transport fluid and with a storage tank for the heat transport fluid, which forms the energy storage and is designed as a stratified storage tank. The thermal energy recovered during wort boiling, which is carried out by supplying external thermal energy, for example via a vapor condenser, is fed to a stratified storage tank as hot heat transport fluid and introduced into its hotter headspace, from where it is fed to a heat exchanger for lauter wort heating, for example, which takes place at a lower temperature level.

In these documents, thermal energy is thus recovered from hotter areas of the brewing process, which is then made available to less hot areas of the brewing process. The wort is always boiled with the addition of external thermal energy, for example by a wort boiler heated with fossil fuels.

DE 30 23 032 A1 shows and describes a method for boiling wort in a brewing plant with a wort kettle and at least one heat exchanger associated to it, through which a high-pressure vapor emitting thermal energy flows on the supply side and which emits thermal energy to the wort on the secondary side. The high-pressure vapor is generated in a heating phase in the direction of flow upstream of the heat exchanger by supplying external energy. When the evaporation temperature of the wort is reached, the heat transfer from the external energy via the high-pressure vapor to the wort is at least partially stopped. In a boiling phase, at least part of the thermal energy of the vapor is boosted by means of a vapor compressor and released back into the wort.

It is known from WO 2006/100 062 A1 to generate high-pressure vapor by supplying external starting energy and drive energy to a vapor compressor, with the temperature of the heat transfer medium being at least 120° C.

### BRIEF SUMMARY OF THE INVENTION

The object of the present invention is to further improve heat recovery in a brewing plant and to further reduce the use of external energy during wort boiling.

This object is achieved by a method for boiling wort in a brewing plant including a wort kettle configured to receive wort and including at least one wort heat exchanger associated with the wort kettle, the method comprising: flowing high-pressure vapor through the at least one wort heat exchanger, emitting thermal energy from the high-pressure vapor to a supply side of the at least one wort heat exchanger and emitting thermal energy to the wort from a secondary side of the at least one wort heat exchanger; generating the high-pressure vapor in a heating phase by supplying external low-temperature start-up energy and supplying drive energy from at least one vapor compressor arranged upstream of the at least one wort heat exchanger; at least partially stopping heat transfer from the external low-temperature start-up energy via the high-pressure vapor to the wort when reaching an evaporation temperature of the wort, wherein exhaust vapor is generated from the wort at the evaporation temperature of the wort; and boosting at least a portion of a thermal energy of the exhaust vapor by the at least one vapor compressor in a boiling phase of the wort and releasing boosted thermal energy back into the wort.

The term low-temperature start-up energy is understood to mean an external start-up energy that heats a heat transfer fluid for thermal energy to a temperature of less than 100° C., advantageously less than 96° C., more advantageously between 60° C. and 95° C.

In the method according to the invention, after an initial heating of the wort by externally supplied thermal low-temperature start-up energy until the wort boiling (heating phase) and the associated generation of exhaust vapor, at least part of the thermal energy of the exhaust vapor is boosted by means of a vapor compressor and released back into the wort. The thermal energy of the exhaust vapor is thus—at least partially—reused, wherein it is boosted by introducing the compressor energy. The mechanical energy required to operate the compressor can be provided by regeneratively generated or CO₂-free electrical energy (e.g. solar energy or wind power). The thermal low-temperature start-up energy can then be reduced or switched off during the wort boiling process (boiling phase).

The method according to the invention allows the provision of thermal low-temperature start-up energy at a temperature level of the heat transfer fluid of below 100° C., advantageously between 6° and 95° C. This enables cost-effective heating with regenerative biomass, such as wood pellets or wood chips, without the use of cost-intensive high-temperature technology. The thermal low-temperature start-up energy can also be obtained from a district heating network that is operated with renewable energies or geothermal energy.

The supply of thermal low-temperature start-up energy is reduced or even switched off completely during this boiling phase, so that little or no external thermal energy is required during the boiling phase. The mechanical or electromechanical energy required to operate the compressor can be obtained without burning fossil fuels and the entire wort boiling process therefore has significantly reduced CO emissions.

Further preferred and advantageous design features of the method according to the invention are specified in dependent claims.

Advantageously, the exhaust vapor is passed through an exhaust vapor compressor, where they are subjected to a pressure and temperature increase in the exhaust vapor compressor, advantageously using mechanical or electromechanical energy, and then release heat energy back into the wort as high-pressure exhaust vapor by means of the wort heat exchanger. Compression can also be carried out as thermal exhaust vapor recompression by means of a thermal compressor, for example a jet pump, especially for larger quantities of vapor. As described above, a small amount of high-pressure vapor is generated in relation to the total amount of vapor, which is then passed through a jet pump, where it draws in a larger amount of low-pressure vapor, which mixes with the high-pressure vapor to generate medium-pressure vapor for heating purposes.

From there, the resulting high-pressure exhaust vapor are fed back to the wort kettle, where they then transfer heat energy back to the wort (boiling phase), whereby the high-pressure exhaust vapor condenses in a heat exchanger associated to the wort kettle.

According to an advantageous embodiment of the method, the high-pressure exhaust vapor is fed into the wort heat exchanger or into another heat exchanger associated to the wort kettle on the supply side, through or past which the wort flows on the secondary side. The high-pressure exhaust vapor is cooled in the heat exchanger on the supply side and condense into exhaust vapor waste water, which can be used for further heat transfer during a brewing process, for example for heating the mash and/or the lauter wort, and is then disposed of.

According to a further embodiment of the method according to the invention, which can be combined with other embodiments, the exhaust vapor are passed through an exhaust vapor heat exchanger associated with the evaporator device, where they transfer heat energy to the liquid evaporator heat transfer fluid, which is then boosted by means of the heat transfer fluid vapor compressor and releases heat energy back to the wort as high-pressure heat transfer fluid vapor by means of a heat exchanger associated with the wort kettle. In this way, the thermal energy of the exhaust vapor is indirectly fed back into the wort. The advantage here is that the high-pressure heat transfer vapor is not contaminated with volatile organic substances from the wort and the vapor can be used for direct injection into the wort. Undesirable organic deposits in the operating network of the high-pressure heat transfer vapor are also avoided.

Advantageously, the high-pressure heat transfer vapor is introduced into the wort kettle, where it condenses and transfers the heat energy directly to the wort. The high-pressure heat transfer vapor, which consists of pure water vapor, dilutes the wort only to a negligible extent and the heat transfer into the wort is very effective.

Advantageously, the evaporator heat transfer fluid is water or a fluid containing water. Water as an evaporator heat transfer fluid and thus as a working medium flowing in the evaporator fluid line arrangement has outstanding properties and advantages over other working media, namely it is naturally available, free of charge almost everywhere, non-toxic, odourless, colorless, environmentally neutral, and chemically stable. In addition, water has favourable physical properties, namely a low-pressure level and a very high enthalpy of vaporization, thus enabling very high coefficients of performance (COP), which are significantly higher than those of other heat transfer media. The use of water as an evaporator heat transfer fluid is therefore ecologically sustainable

According to another embodiment of the method, the high-pressure exhaust vapor is condensed and the exhaust vapor condensate is introduced into the wort. In this way, an essentially closed exhaust vapor cycle is created, although undesirable volatile substances in the wort, for example volatile aromatics, can escape from the exhaust vapor cycle in a gaseous state beforehand or are removed. When introducing the high-pressure exhaust vapor into the wort and the associated condensation process, the heat transfer makes use of the high evaporation and condensation enthalpy of water vapor, so that only very small dilution effects occur with regard to the wort.

The part of the object directed to the brewing plant is solved according to a first embodiment by a brewing plant with at least one wort kettle and a brewing fluid line system in fluid connection therewith for receiving a brewing fluid, with a thermal energy transport system with an evaporator fluid line arrangement, in which an evaporator heat transfer fluid flows, which can be heated by means of a low-temperature primary energy source, wherein the evaporator fluid line arrangement is fluid-connectable or fluid-connected to at least one heating device for the brewing fluid associated with the wort kettle, wherein the wort kettle has an exhaust vapor outlet which is in fluid connection with a low-pressure vapor inlet of an exhaust vapor compressor in a wort energy recovery system via a low-pressure exhaust vapor line, wherein a high-pressure vapor outlet of the exhaust vapor compressor can be brought into fluid connection with a wort heat exchanger associated with the wort kettle via a high-pressure exhaust vapor line, and wherein control means are provided, which are designed to control the low-temperature primary energy source and/or the heat transfer fluid flow in the thermal energy transport system as well as the exhaust vapor flow in the wort energy recovery system. This brewing system is particularly suitable for carrying out the method according to the invention, wherein the brewing fluid is formed by the lauter wort upstream of the wort kettle and by the wort in the wort kettle.

An alternative embodiment of the brewing plant according to the invention is provided with at least one wort kettle and a brewing fluid line system in fluid communication therewith for receiving a brewing fluid, with a thermal energy transport system with an evaporator fluid line arrangement, in which an evaporator heat transfer fluid flows which can be heated by means of a low-temperature primary energy source, wherein the evaporator fluid line arrangement is fluid-connectable or fluid-connected to at least one heating device for the brewing fluid associated with the wort kettle, wherein the wort kettle has an exhaust vapor outlet which is in fluid communication in a wort energy recovery system via a low-pressure exhaust vapor line with a supply side of an exhaust vapor heat exchanger associated with the evaporator device, said exhaust vapor heat exchanger being designed on the secondary side, to transfer the thermal energy to the liquid evaporator heat transfer fluid, and wherein control means are provided which are adapted to control the low temperature primary energy source and/or the heat transfer fluid flow in the thermal energy transport system as well as the exhaust vapor flow in the wort energy recovery system.

With these brewing systems according to the invention, the advantages already mentioned with regard to the method are achieved. The open compression in the exhaust vapor compressor reduces energy losses due to gradients at heat exchangers. These brewing plants are almost infinitely scalable at manageable costs, as exhaust vapor compressors and other compressors are available in the market in all relevant performance classes.

Advantageously, the evaporator fluid line arrangement has an evaporator device and a vapor compressor arranged downstream in the direction of flow of the evaporator heat transfer fluid, wherein the evaporator device is in fluid communication with the vapor compressor via a low-pressure vapor line and wherein the vapor compressor is in fluid connection with the heating device for the brewing fluid via a high-pressure vapor line. The evaporator heat transfer fluid used to heat the lauter wort or the wort and initially also to boil the wort is supplied with mechanical or electromechanical energy in the vapor compressor, which energy can be obtained from regenerative sources in a climate-neutral manner, for example from hydropower or solar energy.

It is advantageous if the evaporator fluid line arrangement has a high-temperature storage arrangement and if the evaporator device is arranged downstream of the high temperature storage arrangement in the direction of flow of the evaporator heat transfer fluid. In this case, the hot heat transfer fluid stored in the high-temperature storage arrangement, for example in the form of a stratified storage arrangement, which fluid has a temperature just below its vapor point, can already be vaporized in the evaporator device by applying only a low negative pressure and thus only a small amount of external energy and fed as vapor to the vapor compressor through a low-pressure vapor line. With water as the heat transfer fluid, the temperature of the hot, liquid water in the upper area of a high-temperature storage arrangement designed as a stratified storage arrangement is just under 100° C. at ambient pressure, for example between 96° C. and 99° C. After the vapor has been compressed by the vapor compressor, the vapor heated by the compression has a temperature of over 100° C. and is in the temperature range of 100° C. to 120° C., for example. In larger plants, it is possible to use two or more vapor compressors in series in order to achieve a particularly large increase in vapor pressure and thus higher heating medium temperatures.

In an advantageous further development of the invention, which can be combined with other embodiments, a high-pressure vapor inlet of the wort kettle has an injection device for introducing water as hot high-pressure heat transfer vapor into the wort kettle or into a wort circulation line. As already explained above, this type of heat transfer into the wort, in which the hot high-pressure heat transfer vapor is introduced into the wort and condensed thereby, takes advantage of the high enthalpy of vaporization and condensation of water vapor, so that the wort is only diluted to a very small extent.

According to a particularly advantageous embodiment of the brewing system according to the invention, at least one low-temperature fluid line arrangement is provided which can be filled or is filled with a low-temperature heat transfer fluid, and has a low-temperature heat exchanger, which is in fluid connection on the supply side with the low-temperature fluid line arrangement and which is in fluid connection on the secondary side with the evaporator fluid line arrangement, wherein on the secondary side the evaporator device is arranged downstream of the low-temperature heat exchanger in the direction of flow of the evaporator heat transfer fluid. In this variant, two heating stages are therefore provided in series one behind the other, namely a low-temperature stage with the low-temperature fluid line arrangement and a high-temperature stage with the evaporator fluid line arrangement. The low-temperature heat transfer fluid in the low-temperature fluid line arrangement is heated to a temperature in the range of approximately 60° C. to 99° C. by supplying external low-temperature start-up energy and transfers its heat in the low-temperature heat exchanger to the evaporator heat transfer fluid in the evaporator fluid line arrangement, where the evaporation and vapor compression described above take place. The low-temperature heat transfer fluid is also advantageously water or contains predominantly water.

The provision of a low-temperature stage that is decoupled from the high-temperature stage, which is partly operated under high pressure and is operated under ambient pressure, has the additional advantage that in the low-temperature fluid line arrangement, in which the external thermal low-temperature start energy is introduced into the brewing system, commercially available heating units can be used without further technical requirements, for example vacuum resistance or overpressure resistance, which are available on the market for building heating at low cost. It is therefore not necessary to use industrially certified and specially tested system components such as pressure accumulators in the low-temperature stage. This significantly reduces system costs.

It is also advantageous if at least one low-temperature storage arrangement for the low-temperature heat transfer fluid is provided in the low-temperature fluid line arrangement upstream of the low-temperature heat exchanger. Such a heat accumulator, which can advantageously also be designed as a stratified heat accumulator, creates a thermal buffer that decouples the release of thermal energy to the evaporator heat transfer fluid from the introduction of the external low-temperature start-up energy. For example, in the case of solar energy as low-temperature start-up energy, irregularities due to passing clouds can be buffered. A major advantage of the thermal buffer is that the required heating power can be reduced to a fraction of the power required during the heating of the wort. Even with continuous loading of the wort kettle, heating usually takes 15 to 30 minutes, followed by a 60 to 90-minute boiling phase and a 10 to 15-minute draining phase. Autonomous boiling by means of exhaust vapor compression according to the invention allows a thermal buffer with a correspondingly low capacity to be continuously loaded, which significantly reduces the investment costs for heat generation. The thermal buffer provided in the second embodiment of the invention also makes it much easier to use electrical energy for larger systems, because significantly smaller electrical connected loads are required, which are power-limited at some locations.

Advantageously, the thermal energy transport system is provided with a low-temperature primary energy source which is designed to introduce thermal energy generated without fossil fuels into the evaporator heat transfer fluid or into the low-temperature heat transfer fluid, advantageously of less than 100° C. Such a low-temperature primary energy source can be, for example, a solar thermal system, a heating system powered by photovoltaics or biogas, a district heating network, or a geothermal heat source. The low-temperature primary energy source supplies the low-temperature start-up energy required to initiate the brewing process.

Advantageously, the primary energy source is provided upstream of the associated storage arrangement in the direction of flow of the heat transfer fluid. As a result, the thermal buffer effect described above can be achieved particularly effectively, especially if the primary energy source is provided directly upstream of the associated storage arrangement in the direction of flow of the heat transfer fluid.

Of course, the primary energy source can be formed by or have a heating device heated with fossil fuel and/or a heating device heated with electrical energy. However, it is ecologically advantageous and particularly sustainable if the low-temperature primary energy source is formed by or comprises a heating device heated with solar energy or biogas and/or using geothermal energy or district heating, as already explained above.

The brewing systems according to the invention can therefore be operated without the use of fossil fuels and, with the use of regeneratively generated electrical energy, a completely CO₂-neutral production method is possible.

### BRIEF DESCRIPTION OF THE DRAWINGS

Advantageous embodiments of the invention with additional embodiment details and further advantages are described and explained in more detail below with reference to the accompanying drawing figure, wherein:

FIG. 1 illustrates a simplified representation of a first embodiment of a brewing plant according to the invention;

FIG. 2 illustrates a modification of the first embodiment of FIG. 1; and

FIG. 3 illustrates a simplified representation of a second embodiment of a brewing plant according to the invention.

### DETAILED DESCRIPTION OF THE INVENTION

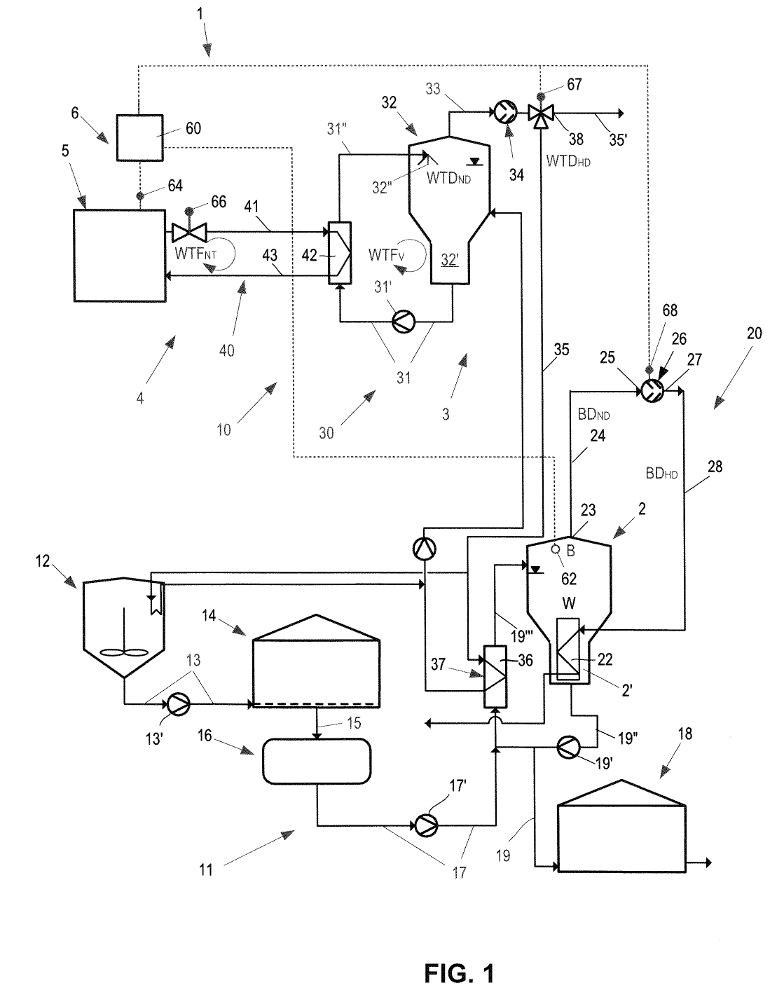

FIG. 1 shows a brewing plant 1 with a mash tun 12, a lauter tun 14, a supply vessel 16, a wort kettle 2 and a whirlpool 18, which are connected to each other in a known manner by lines 13, 15, 17, 19 of a brewing fluid line system 11 in a manner known per se, some of which lines are equipped with feed pumps 13′, 17′. 19′. A pre-masher (not shown) can be connected upstream of the mash tun 12. The process steps of a brewing process which take place in the individual components of the brewing plant 1 are sufficiently well known to the skilled person, so that they will not be discussed further here. The core of the invention lies in thermal energy management, specifically in the thermal energy management of the wort kettle 2, the most energy-intensive system component of the brewing plant 1.

A thermal energy transport system 10 is provided for thermal energy management, which is described in more detail below.

In the example shown, the thermal energy transport system 10 comprises a high temperature stage 3 and a low temperature stage 4 as well as a primary energy source 5. Although the provision of the low temperature stage 4 is advantageous, the low temperature stage 4 can also be omitted if, for example, a sufficiently high temperature-generating primary energy source 5 acts directly on the high temperature stage 3.

A primary energy source 5, shown only schematically and advantageously operated with regenerative energy, for example a solar thermal system, a geothermal system, a district heating supply or a regeneratively operated heating system, heats a low-temperature heat transfer fluid WTF_{NT}, for example water, which is circulated in a low-temperature fluid line arrangement 40, to a temperature below the vapor point, for example from a return temperature in the range of 60° C. to 80° C. to a supply flow temperature in the range between 96° C. and 99° C.

From the primary energy source 5, the low-temperature heat transfer fluid WTF_{NT} heated to the supply flow temperature flows through a low-temperature flow line 41 to a low-temperature heat exchanger 42, through which it flows on the supply side and then—cooled to the return temperature—flows back to the primary energy source 5 through a low-temperature return line 43. The low-temperature heat transfer fluid WTF_{NT} is always in the liquid state in the low-temperature fluid line arrangement 40 and is exposed to normal ambient pressure, i.e. it is not under excess pressure and is also not exposed to negative pressure. The primary energy source 5 is primarily used to get the brewing process running.

An evaporator heat transfer fluid WTF_{V} in the liquid state containing water or consisting entirely of water flows through the low-temperature heat exchanger 42 in counterflow on the secondary side, where it is heated to a temperature between 96° C. and 99° C. and circulated through an evaporator fluid line arrangement 30. The evaporator heat transfer fluid WTF_{V} is conveyed by means of a pump 31′ through an evaporator circuit flow line 31 from a liquid reservoir 32′ of the evaporator device 32 in the liquid state to the low-temperature heat exchanger 42. From the low-temperature heat exchanger 42, the heated liquid evaporator heat transfer fluid WTF_{V} flows through an evaporator circuit return line 31″ to an evaporator nozzle 32″ of the low-pressure evaporator device 32, where it turns to the vapor state and becomes low-pressure heat transfer vapor WTD_{ND} with a temperature below 100° C. The resulting low-pressure vapor is then drawn in by a vapor compressor 34 through a low-pressure vapor line 33.

The vapor compressor 34 is driven by mechanical or electromechanical energy, for example by an electric motor supplied with regenerative or solar-generated electrical energy, and compresses the low-pressure heat transfer vapor WTD_{ND} into high-pressure heat transfer vapor WTD_{HD} and heats it to a temperature of over 100° C. to produce superheated vapor. Downstream of the vapor compressor 34 is a three-way valve 38 with an actuator 38′, which can switch the three-way valve 38 between a first position, in which the high-pressure heat transfer vapor WTD_{HD} is discharged through a high-pressure vapor line 35 to a heat exchanger 36 associated with the wort kettle 2, which forms an external wort boiler 37, and a second position, in which the high-pressure heat transfer vapor WTD_{HD}.is discharged through a discharge line 35′ to other consumers.

The high-pressure heat transfer vapor WTD_{HD} flows from the high-pressure vapor line 35 on the supply side through the heat exchanger 36 and heats the wort W flowing through the heat exchanger 36 on the secondary side in the counterflow direction, which is conveyed by a wort feed pump 19′ through a wort feed line 19″ from a wort reservoir 2′ of the wort kettle 2 to the heat exchanger 36 forming the external wort boiler 37. In the external wort boiler 37, the wort W is heated to boiling temperature and fed back into the wort kettle 2 through a wort return line 19′″. In the wort kettle 2, the vaporous wort collects above the liquid wort reservoir 2′ as exhaust vapor B. The wort feed line 19, the external boiler 37 and the wort return line 19′″ form a first part of a wort energy recovery system 20, through which the wort is passed in its various aggregate states—initially as liquid and later as vaporous wort (exhaust vapor).

The wort kettle 2 has an exhaust vapor outlet 23 in its upper section, which is in direct or indirect fluid connection via a low-pressure exhaust vapor line 24 with a low-pressure vapor inlet 25 of an exhaust vapor compressor 26. The exhaust vapor compressor 26 is also driven by mechanical or electromechanical energy, for example by an electric motor supplied with regenerative or solar-generated electrical energy, and compresses the low-pressure exhaust vapor BD_{ND} into high-pressure exhaust vapor BD_{HD} and heats them to a temperature of advantageously over 110° C. to form superheated vapor. This hot high-pressure exhaust vapor BD_{HD} exit the exhaust vapor compressor 26 through a high-pressure vapor outlet 27 and are conducted through a high-pressure exhaust vapor line 28 to a wort heat exchanger 22 arranged in or on the wort kettle 2, through which it flows on the supply side. In this way, a second part of the wort energy recovery system 20 is formed. The wort heat exchanger can be designed as an internal boiler or as an external boiler. In the case of the internal boiler design, it is surrounded on the secondary side by the wort in the wort reservoir 2′ of the wort kettle 2 and thus heats the wort. The cooled and condensed exhaust vapor leave the wort heat exchanger 22 as vapor waste water, which can be used as a heat source for further process stages. In smaller systems, the wort heat exchanger can also be designed as a kettle heating surface on the base and/or walls.

Alternatively, or additionally, a direct vapor injection with vapor from pure water into the wort kettle 2 could be provided in a start phase, also known as the heating phase, in which the brewing system is heated with the primary energy as external energy. For this heating in the start phase, high-pressure vapor could, for example, be injected into the wort return line 19′″ via the high-pressure vapor line 35 and a connecting line not shown in the figures. However, fresh water must then be fed into the evaporator circuit supply line 31 or the evaporator circuit return line 31′ of the liquid evaporator heat transfer fluid circuit WTF_{V}.

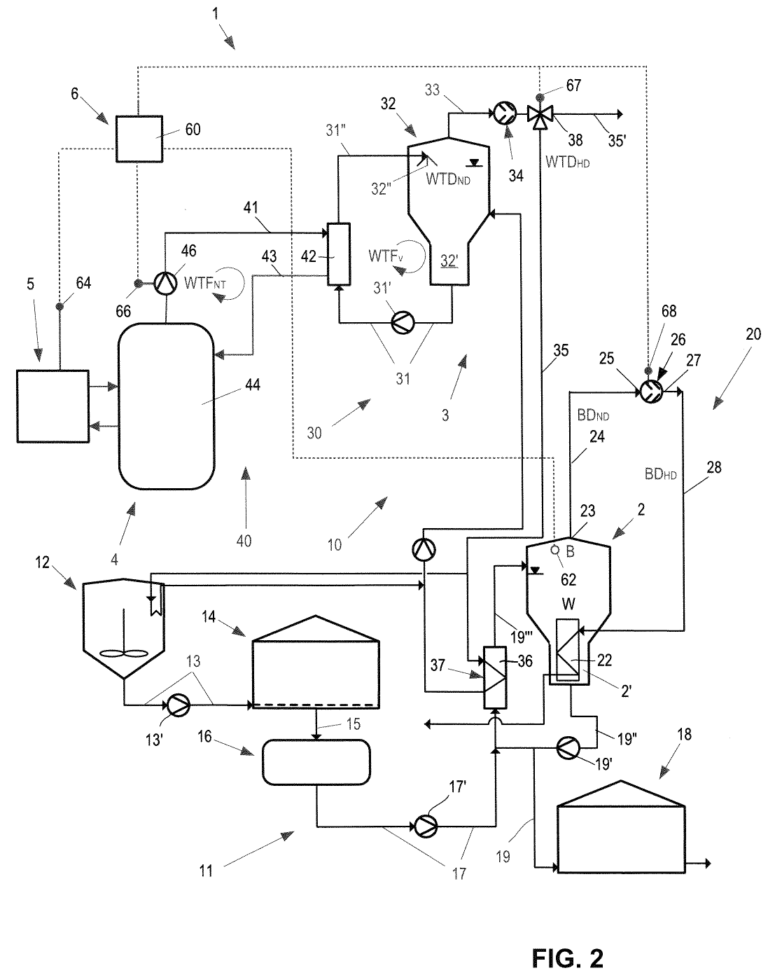

FIG. 2 shows a variant of the brewing system according to the invention that is modified in the low-temperature stage. In contrast to the first variant of the first embodiment in FIG. 1, a low-temperature storage arrangement 44 in the form of a buffer storage tank, which can be designed as a stratified storage tank, is provided here in the low-temperature fluid line arrangement 40. The low-temperature storage arrangement 44 is arranged in the flow line 41 upstream of the low-temperature heat exchanger 42 and buffers the liquid low-temperature heat transfer fluid WTF_{NT} heated by the primary energy source 5. The low-temperature heat transfer fluid WTF_{NT} is fed to the low-temperature heat exchanger 42 by means of a feed pump 46. The structure and mode of operation of this brewing plant 1 otherwise correspond to the brewing plant 1 described in connection with FIG. 1.

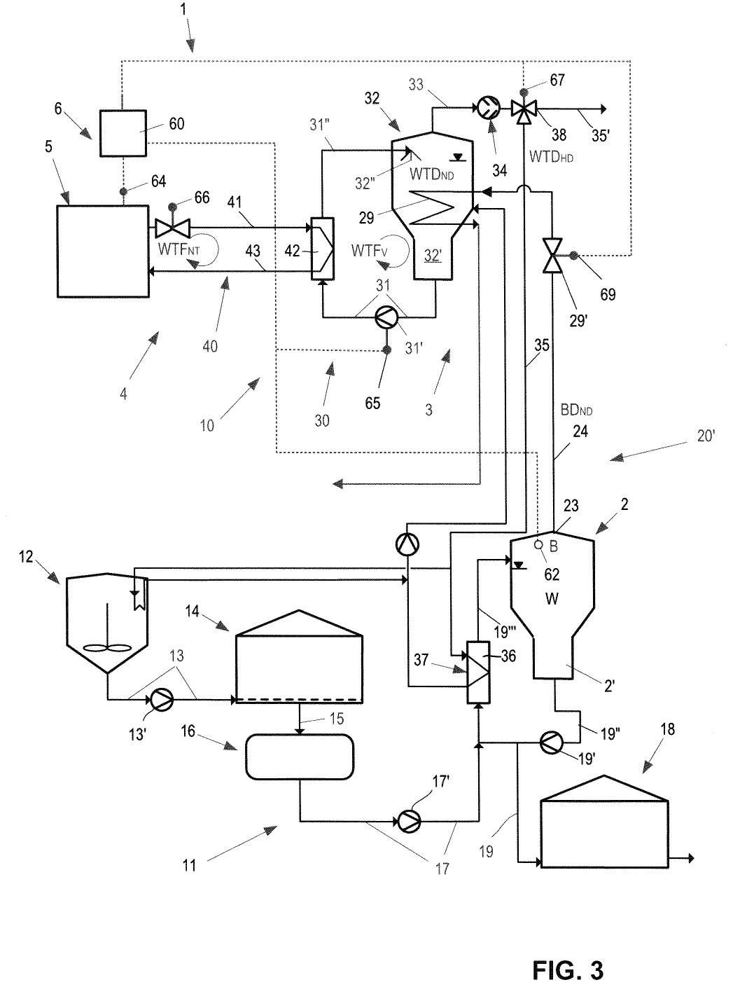

FIG. 3 shows a second embodiment of the invention in which the exhaust vapor in a wort energy recovery system 20′ do not flow through an independent exhaust vapor compressor, but use the vapor compressor 34 of the evaporator fluid line arrangement 30. However, since the exhaust vapor are contaminated with organic substances that are undesirable in the heat transfer fluid circuit and in particular in the evaporator fluid line arrangement 30, the exhaust vapor cannot be introduced directly into the vapor compressor 34 of the evaporator fluid line arrangement 30. For this reason, an exhaust vapor heat exchanger 29 is provided in the evaporator device 32, through which the exhaust vapor supplied by the low-pressure exhaust vapor line 24 flow on the supply side. On the secondary side, the exhaust vapor heat exchanger 29 is surrounded by the low-temperature heat transfer fluid WTF_{NT} or is flowed through by it in the counterflow direction. The largely condensed exhaust vapor emerging from the exhaust vapor heat exchanger 29 are discharged as vapor waste water and can still be used as a heat source for further process stages. The exhaust vapor thus releases thermal energy to the low-temperature heat transfer fluid WTF_{NT}, which, due to the low pressure in the evaporator device 32 at a lower temperature below 100° C., changes to the vapor state and—as described above—is fed to the vapor compressor 34 and compressed there.

Alternatively, the exhaust vapor can also be injected directly into the evaporator device 32, but with the disadvantage that the low-temperature heat transfer fluid WTF_{NT} and subsequently also the evaporator heat transfer fluid WTF_{V} are then contaminated with organic products. If the vapor is fed directly to the compressor, the low-pressure circuit must be switched off using a suitable valve circuit.

In large brewing plants, a second additional compressor with a direct vapor circuit (as described in connection with FIG. 1) is advantageous as it has a higher efficiency because it has to overcome a smaller pressure difference.

In all three embodiments of the invention described, control means are provided which are designed to control the primary energy source 5 and/or the heat transfer fluid flow in the thermal energy transport system 10 as well as the exhaust vapor flow in the wort energy recovery system 20. Although these control means can in principle also be manually operated, a control arrangement 6 with an electronic controller 60 is advantageously provided, which is effectively connected via control lines shown in dashed lines in the figures or wirelessly to at least one exhaust vapor temperature sensor 62, to at least one primary energy actuator 64 and/or at least one heat transfer fluid flow actuator 65, 66, 67 and to at least one exhaust vapor flow actuator 68, 69. The actuators can each be formed by shut-off or changeover valves or their drives, or they can be designed as electrical switches or controllers and, for example, regulate pumps or switch them on or off.

These control means make it possible, for example, to interrupt at least part of the heat transfer from the external low-temperature start energy applied by the primary energy source to the evaporator heat transfer fluid and/or the heat transfer from the evaporator heat transfer fluid to the wort when a predetermined temperature of the wort is reached, namely the boiling temperature, and to pass the exhaust vapor through the exhaust vapor compressor at essentially the same time, in order to cause an increase in pressure and temperature of the exhaust vapor and then to release the thermal energy of the resulting high-pressure exhaust vapor back into the wort. Alternatively, the control means, namely the exhaust vapor actuator 69, cause the exhaust vapor to be introduced into the exhaust vapor heat exchanger 29 by opening the exhaust vapor shut-off valve 29′, whereby the primary energy source or the circuit of the low-temperature heat transfer fluid WTF_{NT} in the low-temperature fluid line arrangement 40 or the circuit of the liquid evaporator heat transfer fluid WTF_{V} in the evaporator fluid line arrangement 30 are switched off at the same time, for example by stopping the pump 31′ by means of the actuator 65 acting on the pump 31′.

Thus, after a start-up phase in which it is heated with the primary energy as external energy, the brewing plant according to the invention can continue to run with exhaust vapor energy recuperation, whereby only the drive energy for the exhaust vapor compressor 26, which is generated regeneratively, for example by solar power, is required for this.

Reference numerals in the description and the drawings are merely intended to facilitate understanding of the invention and do not limit the spirit and scope of the invention which is defined by the appended claims.

### REFERENCE NUMERALS AND DESIGNATIONS

1 Brewing plant
2 Wort kettle
2′ Wort reservoir
3 High temperature stage
4 Low temperature stage
5 Primary energy source
6 Control arrangement
10 Thermal energy transport system
11 Brewing fluid line system
12 Mash tun
13 Line
13′ Feed pump
14 Lauter tun
15 Line
16 Supply vessel
17 Line
17′ Feed pump
18 Whirlpool
19 Line
19′ Wort feed pump
19″ wort supply line
19″ wort return line
20 Wort energy recovery system
20′ Wort energy recovery system
21 Heat exchanger circulation line
22 Wort heat exchanger
23 Exhaust vapor outlet
24 Low-pressure exhaust vapor line
25 Low-pressure vapor inlet
26 Exhaust vapor compressor
27 High-pressure vapor outlet
28 High-pressure exhaust vapor line
29 Exhaust vapor heat exchanger
29′ Exhaust vapor shut-off valve
30 Evaporator fluid line arrangement
31 Evaporator circuit supply line
31′ Pump
31″ Evaporator circuit return line
32 Evaporator device
32′ Liquid reservoir
32″ Evaporator nozzle
33 Low-pressure vapor line
34 Heat transfer fluid vapor compressor
35 High-pressure vapor line
36 Heat exchanger (associated to the wort kettle)
37 External wort boiler
38 Three-way valve
40 Low-temperature fluid line arrangement
41 Supply line
42 Low-temperature heat exchanger
43 Return line
44 Low-temperature storage tank arrangement
46 Supply pump
60 Electronic control
62 Exhaust vapor temperature sensor
64 Primary energy actuator
65 Pump actuator
66 Heat transfer fluid flow actuator
67 Heat transfer fluid flow actuator
68 Exhaust vapor flow actuator
69 Exhaust vapor actuator
B Exhaust vapor
BD_{ND} Low-pressure exhaust vapor
BD_{HD} High-pressure exhaust vapor
W Wort
WTD_{ND} Low-pressure heat transfer vapor
WTD_{HD} High-pressure heat transfer vapor
WTF_{V} Evaporator heat transfer fluid
WTF_{NT} Low-temperature heat transfer fluid (liquid)

What is claimed is:

1. A method for boiling wort in a brewing plant including a wort kettle configured to receive wort and including at least one wort heat exchanger associated with the wort kettle, the method comprising:
flowing high-pressure vapor through the at least one wort heat exchanger, emitting thermal energy from the high-pressure vapor to a supply side of the at least one wort heat exchanger and emitting thermal energy to the wort from a secondary side of the at least one wort heat exchanger;
generating the high-pressure vapor in a heating phase by supplying external low-temperature start-up energy and supplying drive energy from at least one vapor compressor arranged upstream of the at least one wort heat exchanger;
at least partially stopping heat transfer from the external low-temperature start-up energy via the high-pressure vapor to the wort when reaching an evaporation temperature of the wort, wherein exhaust vapor is generated from the wort at the evaporation temperature of the wort; and
boosting at least a portion of a thermal energy of the exhaust vapor by the at least one vapor compressor in a boiling phase of the wort and releasing boosted thermal energy back into the wort.

2. The method according to claim 1, further comprising:
passing the exhaust vapor through an exhaust vapor compressor of the at least one vapor compressor, where the exhaust vapor is subjected to a pressure increase and a temperature increase to form a high-pressure exhaust vapor of the high-pressure vapor;
and then releasing thermal energy from the high-pressure exhaust vapor back to the wort through a first wort heat exchanger of the at least one wort heat exchanger.

3. The method according to claim 2, further comprising: feeding the high-pressure exhaust vapor to the supply side of the first wort heat exchanger or to an additional heat exchanger associated with the wort kettle.

4. The method according to claim 1, further comprising:
passing the exhaust vapor through an exhaust vapor heat exchanger associated with an evaporator device;
transferring thermal energy from the exhaust vapor to a liquid evaporator heat transfer fluid in the exhaust vapor heat exchanger;
boosting the liquid evaporator heat transfer fluid by a heat transfer fluid vapor compressor of the at least one vapor compressor to form a high-pressure heat transfer fluid vapor of the high-pressure vapor and releasing heat energy back to the wort from the high-pressure heat transfer fluid vapor by a second wort heat exchanger of the at least one wort heat exchanger associated with the wort kettle.

5. The method according to claim 4, further comprising:
introducing the high-pressure heat transfer fluid vapor into the wort kettle;
condensing the high-pressure heat transfer fluid vapor in the wort kettle; and
transferring the heat energy directly to the wort.

6. The method according to claim 4, wherein the evaporator heat transfer fluid is water or a fluid containing water.

7. A brewing plant configured to perform the method according to claim 1, the brewing plant comprising:
at least one wort kettle and a brewing fluid line system flow connected therewith and configured to receive a brewing fluid;
a thermal energy transport system including an evaporator fluid line arrangement, in which an evaporator heat transfer fluid flows, which is heatable a low-temperature primary energy source,
wherein the evaporator fluid line arrangement is flow-connectable or flow-connected with at least one heating device for the brewing fluid associated with the wort kettle,
wherein the at least one wort kettle includes an exhaust vapor outlet which is flow connected with a low-pressure vapor inlet of an exhaust vapor compressor in a wort energy recovery system via a low-pressure exhaust vapor line,
wherein a high-pressure vapor outlet of the exhaust vapor compressor is flow connectable with a wort heat exchanger associated to the wort kettle through a high-pressure exhaust vapor line, and
wherein control devices are provided which are configured to control the low-temperature primary energy source and/or heat transfer fluid flow in the thermal energy transport system as well as exhaust vapor flow in the wort energy recovery system.

8. A brewing plant configured to perform the method according to claim 1, the brewing plant comprising:
at least one wort kettle and a brewing fluid line system flow connected therewith and configured to receive a brewing fluid;
a thermal energy transport system including an evaporator fluid line arrangement, in which an evaporator heat transfer fluid flows, which is heatable a low-temperature primary energy source,
wherein the evaporator fluid line arrangement is flow-connectable or flow-connected with at least one heating device for the brewing fluid associated with the wort kettle,
wherein the at least one wort kettle includes an exhaust vapor outlet which is flow connected with a wort energy recovery system via a low-pressure exhaust vapor line with a supply side of an exhaust vapor heat exchanger associated with an evaporator device, wherein the exhaust vapor heat exchanger is configured on a secondary side to transfer thermal energy to a liquid evaporator heat transfer fluid, and,
wherein control devices are provided which configured to control the low-temperature primary energy source and/or heat transfer fluid flow in the thermal energy transport system as well as exhaust vapor flow in the wort energy recovery system.

9. The brewing plant according to claim 7,
wherein the evaporator fluid line arrangement includes an evaporator device and a vapor compressor arranged downstream in a direction of flow of the evaporator heat transfer fluid,
wherein the evaporator device is flow connected with the vapor compressor through a low-pressure vapor line, and
wherein the vapor compressor is flow connected with the at least one heating device for the brewing fluid via a high-pressure vapor line.

10. The brewing plant according to claim 7,
wherein the evaporator fluid line arrangement includes a high-temperature storage arrangement, and
wherein the evaporator device is arranged downstream of the high-temperature storage arrangement in a direction of flow of the evaporator heat transfer fluid.

11. The brewing plant according to claim 7, wherein a high-pressure vapor inlet of the wort kettle includes an injection device configured to introduce water as hot high-pressure heat transfer vapor into the wort kettle or into a wort circulation line.

12. The brewing plant according to claim 7,
wherein at least one low-temperature fluid line arrangement is provided, which is fillable or is filled with a low-temperature heat transfer fluid, and includes a low-temperature heat exchanger, which is flow connected on a supply side with the at least one low-temperature fluid line arrangement and which is flow connected on a secondary side with the evaporator fluid line arrangement,
wherein an evaporator device is arranged on the secondary side downstream of the low-temperature heat exchanger in the direction of flow of the evaporator heat transfer fluid.

13. The brewing plant according to claim 12, further comprising: at least one low-temperature storage arrangement for the low-temperature heat transfer arranged in the low-temperature fluid line arrangement upstream of the low-temperature heat exchanger.

14. The brewing plant according to claim 7, wherein the thermal energy transport system includes a low-temperature primary energy source configured to introduce thermal energy generated without fossil fuels into the evaporator heat transfer fluid or into the low-temperature heat transfer fluid.

15. The brewing plant according to claim 14, wherein the low-temperature primary energy source is arranged upstream of an associated low temperature storage arrangement in a direction of the flow of the heat transfer fluid.

16. The brewing plant according to claim 14, wherein the low-temperature primary energy source is formed by or includes a heating device heated by fossil fuel and/or a heating device heated with electrical energy and/or a heating device heated by solar energy or by biogas and/or a heating device using geothermal energy or district heating.

17. The brewing plant according to claim 8,
wherein the evaporator fluid line arrangement includes an evaporator device and a vapor compressor arranged downstream in a direction of flow of the evaporator heat transfer fluid,
wherein the evaporator device is flow connected with the vapor compressor through a low-pressure vapor line, and
wherein the vapor compressor is flow connected with the at least one heating device for the brewing fluid via a high-pressure vapor line.

18. The brewing plant according to claim 8,
wherein the evaporator fluid line arrangement includes a high-temperature storage arrangement, and
wherein the evaporator device is arranged downstream of the high-temperature storage arrangement in a direction of flow of the evaporator heat transfer fluid.

19. The brewing plant according to claim 8, wherein a high-pressure vapor inlet of the wort kettle includes an injection device configured to introduce water as hot high-pressure heat transfer vapor into the wort kettle or into a wort circulation line.

20. The brewing plant according to claim 8,
wherein at least one low-temperature fluid line arrangement is provided, which is fillable or is filled with a low-temperature heat transfer fluid, and includes a low-temperature heat exchanger, which is flow connected on a supply side with the at least one low-temperature fluid line arrangement and which is flow connected on a secondary side with the evaporator fluid line arrangement,
wherein an evaporator device is arranged on the secondary side downstream of the low-temperature heat exchanger in the direction of flow of the evaporator heat transfer fluid.
